(19) United States
(12) Patent Application Publication
(10) Pub. No.: US 2022/0100389 A1
(43) Pub. Date: Mar. 31, 2022

(54) METHOD, ELECTRONIC DEVICE, AND COMPUTER PROGRAM PRODUCT FOR MANAGING DISK

(71) Applicant: EMC IP Holding Company, LLC, Hopkinton, MA (US)

(72) Inventors: Shuo Lv, Beijing (CN); Bo Gao, Beijing (CN)

(21) Appl. No.: 17/487,489

(22) Filed: Sep. 28, 2021

(30) Foreign Application Priority Data
Sep. 29, 2020 (CN) 202011056677.9

(51) Int. Cl. G06F 3/06; G06F 11/34; G06F 11/30; G06N 5/00; G06N 3/08

(52) U.S. Cl. CPC G06F 3/0614; G06F 3/0653; G06F 3/0674; G06N 3/08; G06F 11/3034; G06N 5/003; G06F 11/3447

(57) ABSTRACT

Embodiments of the present disclosure relate to a method, an electronic device, and a computer program product for managing a disk. The method includes: acquiring a model for determining a remaining life of a disk, wherein the model is trained by taking a set of parameters related to a failure of a group of reference disks as an input and taking a reference remaining life of the group of reference disks at the time when the set of parameters are acquired as an output; acquiring a parameter related to a remaining life of a target disk, wherein the parameter indicates usage information of the target disk when it is used; and applying the parameter to the model to determine the remaining life of the target disk. With the technical solution of the present disclosure, a remaining life of a disk can be predicted, so that the disk can be actively replaced before it fails. This not only can increase the reliability of a storage system, but also can reduce the time taken to reconstruct the storage system, thereby improving user experience of a user of the storage system.

### RELATED APPLICATION(S)

This application claims the priority of Chinese Patent Application No. 202011056677.9, filed on 29 Sep. 2020, the entire contents of which are herein incorporated by reference in its entirety.

### TECHNICAL FIELD

Embodiments of the present disclosure generally relate to the field of data storage, and more particularly, to a method, an electronic device, and a computer program product for managing a disk.

### BACKGROUND

In data storage systems, disks or hard drives are components that are easy to fail. Although a large number of protection mechanisms such as mapped redundant array of independent disks (RAID) and high availability (HA) are adopted, the availability and reliability of a storage system will still be severely affected when a disk or hard disk fails. In this case, the user experience will be affected accordingly.

### SUMMARY OF THE INVENTION

Embodiments of the present disclosure provide a method, an electronic device, and a computer program product for managing a disk.

In a first aspect of the present disclosure, a method for managing a disk is provided. The method includes: acquiring a model for determining a remaining life of a disk, wherein the model is trained by taking a set of parameters related to a failure of a group of reference disks as an input and taking a reference remaining life of the group of reference disks at the time when the set of parameters are acquired as an output; acquiring a parameter related to a remaining life of a target disk, wherein the parameter indicates usage information of the target disk when it is used; and applying the parameter to the model to determine the remaining life of the target disk.

In a second aspect of the present disclosure, an electronic device is provided. The device includes: at least one processing unit; and at least one memory which is coupled to the at least one processing unit and stores instructions for execution by the at least one processing unit, wherein the instructions, when executed by the at least one processing unit, cause the device to perform actions including: acquiring a model for determining a remaining life of a disk, wherein the model is trained by taking a set of parameters related to a failure of a group of reference disks as an input and taking a reference remaining life of the group of reference disks at the time when the set of parameters are acquired as an output; acquiring a parameter related to a remaining life of a target disk, wherein the parameter indicates usage information of the target disk when it is used; and applying the parameter to the model to determine the remaining life of the target disk.

In a third aspect of the present disclosure, a computer program product is provided. The computer program product is tangibly stored on a non-transitory computer-readable medium and includes machine-executable instructions, wherein the machine-executable instructions, when executed, cause a machine to perform any step of the method described according to the first aspect of the present disclosure.

The summary part is provided in order to introduce the selection of concepts in a simplified form, which will be further described in the detailed description below. The summary part is not intended to identify key features or essential features of the embodiments of the present disclosure, nor is it intended to limit the scope of the embodiments of the present disclosure.

### BRIEF DESCRIPTION OF THE DRAWINGS

The above and other objectives, features, and advantages of the present disclosure will become more apparent by describing example embodiments of the present disclosure in more detail in combination with the accompanying drawings. In the example embodiments of the present disclosure, the same reference numerals generally represent the same parts.

FIG. 1 illustrates a schematic diagram of disk management environment 100 in which a method for managing a disk in some embodiments of the present disclosure can be implemented;

FIG. 2 illustrates a flowchart of method 200 for managing a disk according to an embodiment of the present disclosure;

FIG. 3 illustrates a flowchart of method 300 for training a model according to an embodiment of the present disclosure; and

FIG. 4 illustrates a schematic block diagram of example device 400 that can be used to implement the embodiments of the present disclosure.

The same or corresponding reference numerals in the various drawings represent the same or corresponding portions.

### DETAILED DESCRIPTION

Hereinafter, preferred embodiments of the present disclosure will be described in more detail with reference to the accompanying drawings. Although the preferred embodiments of the present disclosure are shown in the drawings, it should be understood that the present disclosure can be implemented in various forms and should not be limited by the embodiments set forth herein. Rather, these embodiments are provided so that this disclosure will be more thorough and complete, and will fully convey the scope of the present disclosure to those skilled in the art.

As used herein, the term “include” and variations thereof mean open-ended inclusion, for example, “including but not limited to.” Unless specifically stated, the term “or” means “and/or.” The term “based on” means “based at least in part on.” The terms “an example embodiment” and “an embodiment” mean “at least one embodiment.” The term “another embodiment” means “at least one further embodiment.” The terms “first,” “second,” etc., may refer to different or the same objects. Other explicit and implicit definitions may also be included below.

In a conventional storage system, when a disk fails, reconstruction work will be started. Take a mapped RAID as an example, when the mapped RAID is in a degraded state due to the start of reconstruction work, user input and output (10) will be severely affected. Specifically, in the mapped RAID, when a disk is removed, many RAID extents of the mapped RAID may be affected. Dead disk extents will be replaced with other disks in a disk pool. At this time, the dead disk extents will be reconstructed based on a conventional logic and according to an indexing order of the RAID extents.

In some solutions, parallel reconstruction has been introduced in a mapped RAID, so that multiple disk extents can be reconstructed at the same time. In the parallel reconstruction, if the reconstruction of any RAID extent has been completed, a next RAID that needs to be reconstructed will be sequentially added to the parallel reconstruction list until full reconstruction is completed. However, the aforementioned mechanisms are all adopted when a disk fails. Reconstructing a storage system after a disk fails still cannot completely solve the availability and reliability problems of the storage system, and the user input and output performance during the time spent in reconstruction will be greatly reduced, so it will affect the user experience.

In order to at least partially solve the above problems and one or more of other potential problems, the embodiments of the present disclosure propose a solution for managing a disk. With this solution, a remaining life of a disk can be predicted before the disk fails, for example, the time when the disk will fail, so that the availability and reliability of a storage system can be improved by replacing in advance the disk that will fail, and the impact on a user's input and output during disk reconstruction can be reduced.

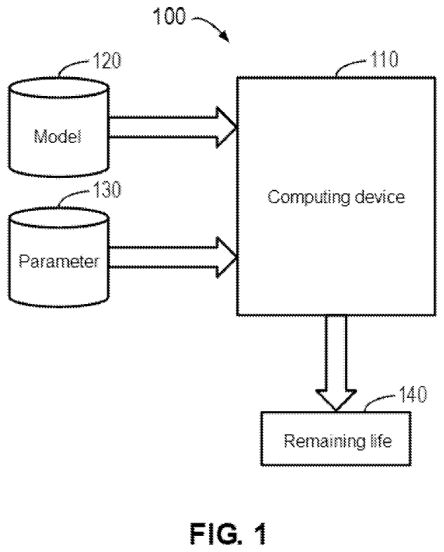

FIG. 1 illustrates a schematic diagram of disk management environment 100 in which a method for managing a disk in some embodiments of the present disclosure can be implemented. According to an embodiment of the present disclosure, disk management environment 100 may be a cloud environment. As shown in FIG. 1, disk management environment 100 includes computing device 110. In disk management environment 100, model 120 for determining a remaining life of a disk and parameters 130 related to a remaining life of a target disk are provided to computing device 110 as an input to computing device 110, and remaining life 140 of the target disk is used as an output and is output by computing device 110.

It should be understood that disk management environment 100 is only illustrative rather than restrictive, and it is extensible, which may include more computing devices 110, and may provide more models 120 and parameters 130 to computing devices 110 as an input, and computing device 110 may also output more remaining life 140 as an output, so that the demand of more users for using more computing devices 110, or even using more models 120 to determine remaining life 140 of more target disks at the same time can be met.

According to the embodiment of the present disclosure, in disk management environment 100, model 120 provided to computing device 110 is used to determine a remaining life of a disk, and model 120 is trained by taking a set of parameters related to a failure of a group of reference disks as an input and taking a reference remaining life of the group of reference disks at the time when the set of parameters are acquired as an output.

During the operation of the storage system, various technologies can be used to monitor and record various parameters of the disk. For example, the self-monitoring, analyzing, and reporting technology (S.M.A.R.T) is a built-in supplementary component in many modern storage systems. Through the self-monitoring, analyzing, and reporting technology, a storage system can monitor, store, and analyze the operating condition of a disk. Specifically, the self-monitoring, analyzing, and reporting technology can provide various parameters related to the operating condition of the disk, wherein these parameters are indicators of the health condition and the internal operating condition of the disk. The self-monitoring, analyzing, and reporting technology can collect statistical information such as the temperature of the disk, the number of reallocated sectors, and finding errors, and can use these statistical information to measure the operating condition of a device. According to an embodiment of the present disclosure, the statistical information can be used to train model 120 and used as an input to computing device 110.

The parameters provided by the self-monitoring, analyzing, and reporting technology can be referred to as self-monitoring, analyzing, and reporting technological parameters. These parameters involve up to 30 disk attributes, for example, reallocated sector count (RSC), spin-up time (SUT), seek error rate (SER), temperature in Celsius (TC), and power-on hours (POH). These parameters are indicators of the health condition and the internal working condition of the disk. For example, the value of the reallocated sector count indicates the number of bad sectors on the disk and can indicate the operating condition of the disk medium. The spin-up time and the change in the temperature in Celsius are closely related to the working condition of a spindle motor.

Thresholds can be set for the self-monitoring, analyzing, and reporting technological parameters, wherein the thresholds cannot be exceeded under normal operations. Each parameter may have an original value, wherein this original value may be, for example, a decimal or hexadecimal value, and its meaning may correspond to a count or a physical unit, for example, degree Celsius or second. According to an embodiment of the present disclosure, these parameters can be normalized, and the range of their normalized values can be, for example, from 1 to 253 (where 1 represents the worst case while 253 represents the best case), and the worst value represents the lowest normalized value recorded. In the case where normalization is performed, an initial default value of a normalized parameter may be, for example, 100.

According to an embodiment of the present disclosure, model 120 that is used as an input to computing device 110 and used to determine a remaining life of a disk may be a machine learning model, for example, a random forest model or a neural network model. Random forest is a holistic machine learning method for classification, regression, and other tasks. It operates by constructing a large number of decision trees during training and outputting classes as individuals (classification) or classes as mean prediction (regression) modes. Random forest can correct the decision trees' habit of overfitting their training sets.

According to an embodiment of the present disclosure, when computing device 110 in disk management environment 100 receives trained model 120 and parameters 130 for the target disk and related to the remaining life, computing device 110 may apply parameters 130 to model 120 to determine remaining life 140 of the target disk as an output.

In disk management environment 100 shown in FIG. 1, inputting model 120 and parameters 130 to computing device 110 and outputting remaining life 140 from computing device 110 may be performed through a network.

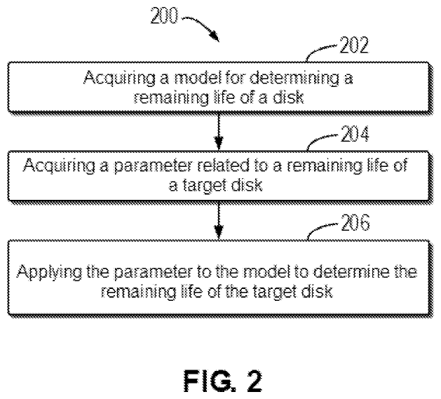

FIG. 2 illustrates a flowchart of method 200 for managing a disk according to an embodiment of the present disclosure. Method 200 may be implemented by computing device 110 in disk management environment 100 or by other appropriate devices. It should be understood that method 200 for managing a disk may further include additional steps not shown and/or may omit the shown steps, and the scope of the embodiments of the present disclosure is not limited in this respect.

In block 202, computing device 110 acquires model 120 for determining a remaining life of a disk. According to an embodiment of the present disclosure, model 120 is trained by taking a set of parameters related to a failure of a group of reference disks as an input and taking a reference remaining life of the group of reference disks at the time when the set of parameters are acquired as an output, and model 120 may be, for example, a random forest model or a neural network model.

In block 204, computing device 110 acquires parameters 130 related to a remaining life of a target disk. According to an embodiment of the present disclosure, parameter 130 indicates usage information of the target disk when it is used, and may include, for example, self-monitoring, analyzing, and reporting technological parameters. According to the embodiment of the present disclosure, in the self-monitoring, analyzing, and reporting technological parameters, some self-monitoring, analyzing, and reporting technological parameters can be used to indicate that the disk will fail and need to be replaced. Specifically, for these self-monitoring, analyzing, and reporting technological parameters, their values will change significantly within a period of time relatively close to and before the disk fails, for example, within a few days. Therefore, it can be determined that the disk will fail by monitoring changes in the values of these parameters. According to an embodiment of the present disclosure, these parameters may be, for example, recoverable read error rate (RRER), start and stop count (SSC), reallocated sector count (RSC), seek error rate (SER), power-on hours (POH), spin-up time (SUT), reported unrecoverable error count (RUE), command timeout (CT), airflow temperature in Celsius (ATC), load cycle count (LCC), temperature in Celsius (TC), currently pending sector (CPS), offline uncorrectable (OU), head flying time (HFH), total logical block address writes (TLW), total logical block address reads (TLR), etc.

It should be understood that parameters 130 may have various implementation forms, and does not need to include all the parameters listed above, but may include some of them. In this case, the model can be adjusted so that remaining life 140 of the target disk can be determined through these parameters.

In block 206, computing device 110 applies parameters 130 acquired in block 204 to model 120 acquired in block 202 to determine remaining life 140 of the target disk.

According to an embodiment of the present disclosure, a threshold remaining time may be set so that, if computing device 110 determines that remaining life 140 is shorter than the threshold remaining time, it is determined that the target disk needs to be replaced.

According to method 200 described above in connection with FIG. 2, it can be seen that method 200 includes using trained model 120 that is used to determine a remaining life of a disk and parameters 130 related to the remaining life of the target disk to determine remaining life 140 of the target disk. The training process of model 120 for determining a remaining life of a disk will be further described below.

FIG. 3 illustrates a flowchart of method 300 for training a model according to an embodiment of the present disclosure. Method 300 may likewise be implemented by computing device 110 in disk management environment 100 or by other appropriate devices. It should be understood that method 300 may further include additional steps not shown and/or may omit the shown steps, and the scope of the present disclosure is not limited in this respect.

In block 302, computing device 110 acquires a set of parameters related to a failure of a group of reference disks. According to an embodiment of the present disclosure, a large number of parameters of a disk from normal operation to failure can be collected. When the disk fails, a large number of parameters collected within a period of time going back from the failure of the disk can be selected. The interval for collecting parameters may be fixed or not, and the interval for collecting parameters may be any suitable interval, for example, 1 second, 1 minute, 10 minutes, 1 hour, etc. It should be understood that the smaller the interval for collection, the more accurately it is possible to determine the remaining life of target disk 140. At the same time, according to the embodiment of the present disclosure, it is possible to determine, according to how long in advance it needs to determine that the disk is about to fail, the time range from the collection of the selected parameters to the failure of the disk. For example, if it is desired to predict, 14 days in advance, that the disk will fail, the parameters within 14 days going back from the failure of the disk can be collected. As previously mentioned, the parameters collected for each disk in the group of reference disks may include: recoverable read error rate (RRER), start and stop count (SSC), reallocated sector count (RSC), seek error rate (SER), power-on hours (POH), spin-up time (SUT), reported unrecoverable error count (RUE), command timeout (CT), airflow temperature in Celsius (ATC), load cycle count (LCC), temperature in Celsius (TC), currently pending sector (CPS), offline uncorrectable (OU), head flying time (HFH), total logical block address writes (TLW), and total logical block address reads (TLR). The set of these parameters constitutes a set of parameters related to a failure of a group of reference disks, and can be used as an input for training model 120.

In block 304, computing device 110 acquires a reference remaining life of the group of reference disks at the time when the set of parameters are acquired. According to an embodiment of the present disclosure, when the set of parameters are collected, the reference remaining life of the disks corresponding to the parameters in the set of parameters is also collected. In this way, multiple parameter pairs of parameters/reference remaining life can be formed. For example, if a disk fails at 5:00 on January 3, the reference remaining life of this disk corresponding to the parameters collected for this disk at 6:00 on January 1 is 47 hours.

In block 306, computing device 110 acquires additional parameters for adjusting the training of model 120. According to an embodiment of the present disclosure, the additional parameters may include weights of the set of parameters. Among the various parameters mentioned above, a change of some parameters is easier to directly indicate the remaining life of the disk. Therefore, when model 120 is trained, weights can be added to these parameters so that these parameters can be made more decisive when model 120 is trained.

According to an embodiment of the present disclosure, the additional parameters may further include a time range between a time point when the set of parameters are acquired and a time point when the failure occurs. As previously mentioned, if it is desired to predict, 14 days in advance, that the disk will fail, the parameters within 14 days going back from the failure of the disk can be collected. At this time, the aforementioned time range can be set to 0-14 days. It should be understood that the time range can also be set to, for example, 1-14 days or even 7-14 days, because the embodiments of the present disclosure pay more attention to how long in advance a disk can be predicted to fail. Therefore, as long as it can be guaranteed that model 120 can be trained to correctly predict, at a preset time in advance, that the disk will fail, there is no need to pay too much attention to the parameter situation at the time when an adjacent disk actually fails.

According to an embodiment of the present disclosure, when model 120 is a random forest model, the additional parameter may further include the number of trees in the random forest model. The number of trees in the random forest model may correspond to the number of parameters in the set of parameters input to model 120. Therefore, the number of parameters in the set of parameters used to train model 120 can be adjusted by adjusting the number of trees in the random forest model.

According to an embodiment of the present disclosure, block 306 in method 300 is an optional block, and method 300 may also work normally without block 306, because model 120 may also be trained without additional parameters.

In block 308, computing device 110 trains model 120 by taking the set of parameters and the additional parameters as an input and taking the reference remaining life as an output. As previously described, since block 306 is an optional block, when block 306 is not selected, in block 308, computing device 110 trains model 120 by taking the set of parameters as an input and taking the reference remaining life as an output.

According to an embodiment of the present disclosure, since the units of various parameters are not the same, in order to facilitate the processing of these parameters by model 120, these parameters can be normalized, and then used as an input to train the model 120. For example, the above normalization process can be realized by the following formula (1):

$${x}_{N} = \frac{x - {x}_{min}}{{x}_{max} - {x}_{min}} \qquad ( 1 )$$

where x represents the current value of a parameter, xₘᵢₙ and xₘₐₓ represent the minimum and maximum values of the parameter, and x_{N} represents the normalized value of x.

According to an embodiment of the present disclosure, when computing device 110 trains model 120, the set of parameters can be divided into a first subset of parameters and a second subset of parameters, wherein the first subset of parameters are used to train model 120, and the second subset of parameters are used to test the trained model 120. The ratio of parameters included in the first subset of parameters and the second subset of parameters may be, for example, 7:3. It should be understood that this ratio is only illustrative, and it can be adjusted according to the number of parameters in the set of parameters as well as the training situation or prediction accuracy of model 120.

Through testing, by using model 120 trained through method 300 to execute method 200 for managing a disk, the accuracy of correctly predicting a remaining life of a target disk can reach at least 90%.

Contents related to disk management environment 100 in which the method for managing a disk in some embodiments of the present disclosure can be implemented, method 200 for managing a disk according to the embodiments of the present disclosure, and method 300 for training a model according to the embodiments of the present disclosure have been described above with reference to FIGS. 1 to 3. It should be understood that the above description is to better demonstrate the content recorded in the embodiments of the present disclosure, and is not intended to limit the present disclosure in any way.

It should be understood that the numbers of various elements and the magnitudes of physical quantities used in the embodiments of the present disclosure and the drawings are only examples, and are not intended to limit the protection scope of the embodiments of the present disclosure. The above numbers and magnitudes can be arbitrarily set according to needs without affecting the normal implementation of the embodiments of the present disclosure.

Through the above description with reference to FIGS. 1 to 3, the technical solutions according to the embodiments of the present disclosure have many advantages over conventional solutions. For example, with the technical solution of the present disclosure, a remaining life of a disk can be predicted, so that the disk can be actively replaced before it fails. This not only can increase the reliability of a storage system, but also can reduce the time taken to reconstruct the storage system, thereby improving the user experience of a user of the storage system.

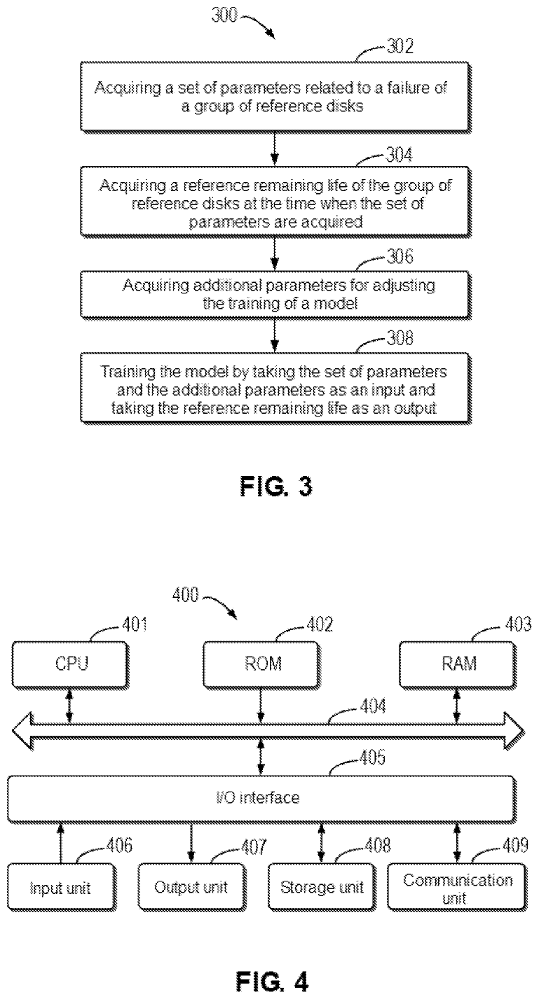

FIG. 4 illustrates a schematic block diagram of example device 400 that can be used to implement the embodiments of the present disclosure. According to an embodiment of the present disclosure, management device 124 shown in FIG. 1 may be implemented as example device 400. As shown in the drawing, device 400 includes central processing unit (CPU) 401 that may perform various appropriate actions and processing according to computer program instructions stored in read-only memory (ROM) 402 or computer program instructions loaded from storage unit 408 into random access memory (RAM) 403. In RAM 403, various programs and data required for the operation of storage device 400 may also be stored. CPU 401, ROM 402, and RAM 403 are connected to each other through bus 404. Input/output (I/O) interface 405 is also connected to bus 404.

Multiple components in device 400 are connected to I/O interface 405, including: input unit 406, such as, for example, a keyboard, and a mouse; output unit 407, such as, for example, various types of displays, and speakers; storage unit 408, such as, for example, a magnetic disk, and an optical disk; and communication unit 409, such as, for example, a network card, a modem, and a wireless communication transceiver. Communication unit 409 allows device 400 to exchange information/data with other devices through a computer network such as the Internet and/or various telecommunication networks.

The various processes and processing described above, such as methods 200 and 300, may be performed by processing unit 401. For example, in some embodiments, methods 200 and 300 may be implemented as a computer software program that is tangibly included in a machine-readable medium such as storage unit 408. In some embodiments, part or all of the computer program may be loaded and/or mounted to device 400 via ROM 402 and/or communication unit 409. One or more actions of methods 200 and 300 described above may be performed when the computer program is loaded into RAM 403 and executed by CPU 401.

The embodiments of the present disclosure may relate to a method, a device, a system, and/or a computer program product. The computer program product may include a computer-readable storage medium on which computer-readable program instructions for performing various aspects of the embodiments of the present disclosure are carried.

The computer-readable storage medium may be a tangible device that can hold and store instructions used by an instruction execution device. The computer-readable storage medium may be, for example, but are not limited to, an electric storage device, a magnetic storage device, an optical storage device, an electromagnetic storage device, a semiconductor storage device, or any suitable combination of the foregoing. More specific examples, as a non-exhaustive list, of computer-readable storage media include: a portable computer disk, a hard disk, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. Computer-readable storage media used herein are not to be interpreted as transient signals per se, such as radio waves or other freely propagating electromagnetic waves, electromagnetic waves propagating through waveguides or other transmission media, for example, light pulses through fiber optic cables, or electrical signal transmitted via electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

Computer program instructions for performing the operations of the embodiments of the present disclosure may be assembly instructions, instruction set architecture (ISA) instructions, machine instructions, machine-related instructions, microcode, firmware instructions, state setting data, or source or object code written in any combination of one or more programming languages, wherein the programming languages include object-oriented programming languages, such as Smalltalk and C++, and conventional procedural programming languages, such as the “C” language or similar programming languages. Computer-readable program instructions may be executed entirely on a user's computer, partly on a user's computer, as a stand-alone software package, partly on a user's computer and partly on a remote computer, or entirely on a remote computer or server. In the case involving a remote computer, the remote computer can be connected to a user's computer through any kind of network, including a local area network (LAN) or a wide area network (WAN), or it can be connected to an external computer, for example, connected through an Internet using an Internet service provider. In some embodiments, an electronic circuit, for example, a programmable logic circuit, a field programmable gate array (FPGA), or a programmable logic array (PLA), is personalized by utilizing the state information of the computer-readable program instructions, wherein the electronic circuit may execute computer-readable program instructions so as to implement various aspects of the embodiments of the present disclosure.

Various aspects of the embodiments of the present disclosure are described here with reference to the flowcharts and/or block diagrams of the methods, the devices/systems, and the computer program products according to the embodiments of the present disclosure. It should be understood that each block of the flowcharts and/or block diagrams and combinations of blocks in the flowcharts and/or block diagrams can be implemented by computer-readable program instructions.

These computer-readable program instructions can be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing the functions/actions specified in one or more blocks in the flowcharts and/or block diagrams. These computer-readable program instructions may also be stored in a computer-readable storage medium, and these instructions cause a computer, a programmable data processing apparatus, and/or other devices to work in a specific manner; and thus the computer-readable medium having stored instructions includes an article of manufacture including instructions that implement various aspects of the functions/actions specified in one or more blocks in the flowcharts and/or block diagrams.

The computer-readable program instructions can also be loaded onto a computer, a further programmable data processing apparatus, or a further device, so that a series of operating steps can be performed on the computer, the further programmable data processing apparatus, or the further device to produce a computer-implemented process, such that the instructions executed on the computer, the further programmable data processing apparatus, or the further device can implement the functions/actions specified in one or more blocks in the flowcharts and/or block diagrams.

The flowcharts and block diagrams in the drawings illustrate the architectures, functions, and operations of possible implementations of the systems, methods and computer program products according to various embodiments of the present disclosure. In this regard, each block in the flowcharts or block diagrams may represent a module, a program segment, or part of an instruction, the module, the program segment, or the part of an instruction including one or more executable instructions for implementing specified logical functions. In some alternative implementations, the functions marked in the blocks may also occur in an order different from that marked in the accompanying drawings. For example, two successive blocks may actually be executed in parallel substantially, or they may be executed in an opposite order sometimes, depending on the functions involved. It should be further noted that each block in the block diagrams and/or flowcharts as well as a combination of blocks in the block diagrams and/or flowcharts may be implemented by using a special hardware-based system for executing specified functions or actions or by a combination of special hardware and computer instructions.

The embodiments of the present disclosure have been described above. The above description is illustrative, rather than exhaustive, and is not limited to the disclosed embodiments. Numerous modifications and alterations are apparent to those of ordinary skill in the art without departing from the scope and spirit of the illustrated various embodiments. The selection of terms as used herein is intended to best explain the principles and practical applications of the various embodiments or technical improvements to technologies on the market, or to enable other persons of ordinary skill in the art to understand the various embodiments disclosed herein.

1. A method for managing a disk, including:
acquiring a model for determining a remaining life of a disk, wherein the model is trained by taking a set of parameters related to a failure of a group of reference disks as an input and taking a reference remaining life of the group of reference disks at the time when the set of parameters are acquired as an output;
acquiring a parameter related to a remaining life of a target disk, wherein the parameter indicates usage information of the target disk when it is used; and
applying the parameter to the model to determine the remaining life of the target disk.

2. The method according to claim 1, wherein acquiring the parameter includes acquiring at least one of the following of the target disk: recoverable read error rate, start and stop count, reallocated sector count, seek error rate, power-on hours, spin-up time, reported unrecoverable error count, command timeout, airflow temperature in Celsius, load cycle count, temperature in Celsius, currently pending sector, offline uncorrectable, head flying time, total logical block address writes, and total logical block address reads.

3. The method according to claim 1, wherein the model is a random forest model or a neural network model.

4. The method according to claim 1, further including:
acquiring additional parameters for adjusting the training of the model; and
training the model by taking the set of parameters and the additional parameters as an input and taking the reference remaining life as an output.

5. The method according to claim 4, wherein the additional parameters include at least one of the following:
weights of the set of parameters;
a time range between a time point when the set of parameters are acquired and a time point when the failure occurs; and
the number of trees included in the model, the model being a random forest model.

6. The method according to claim 1, further including:
determining that the target disk needs to be replaced if it is determined that the remaining life is shorter than a threshold remaining time.

7. An electronic device, including:
at least one processing unit; and
at least one memory which is coupled to the at least one processing unit and stores instructions for execution by the at least one processing unit, wherein the instructions, when executed by the at least one processing unit, cause the device to perform actions including:
acquiring a model for determining a remaining life of a disk, wherein the model is trained by taking a set of parameters related to a failure of a group of reference disks as an input and taking a reference remaining life of the group of reference disks at the time when the set of parameters are acquired as an output;
acquiring a parameter related to a remaining life of a target disk, wherein the parameter indicates usage information of the target disk when it is used; and
applying the parameter to the model to determine the remaining life of the target disk.

8. The device according to claim 7, wherein acquiring the parameter includes acquiring at least one of the following of the target disk: recoverable read error rate, start and stop count, reallocated sector count, seek error rate, power-on hours, spin-up time, reported unrecoverable error count, command timeout, airflow temperature in Celsius, load cycle count, temperature in Celsius, currently pending sector, offline uncorrectable, head flying time, total logical block address writes, and total logical block address reads.

9. The device according to claim 7, wherein the model is a random forest model or a neural network model.

10. The device according to claim 7, wherein the actions further include:
acquiring additional parameters for adjusting the training of the model; and
training the model by taking the set of parameters and the additional parameters as an input and taking the reference remaining life as an output.

11. The device according to claim 10, wherein the additional parameters include at least one of the following:
weights of the set of parameters;
a time range between a time point when the set of parameters are acquired and a time point when the failure occurs; and
the number of trees included in the model, the model being a random forest model.

12. The device according to claim 7, wherein the actions further include:
determining that the target disk needs to be replaced if it is determined that the remaining life is shorter than a threshold remaining time.

13. A computer program product tangibly stored in a non-transitory computer-readable medium and including machine-executable instructions, wherein the machine-executable instructions, when executed, cause a machine to perform steps including:
acquiring a model for determining a remaining life of a disk, wherein the model is trained by taking a set of parameters related to a failure of a group of reference disks as an input and taking a reference remaining life of the group of reference disks at the time when the set of parameters are acquired as an output;
acquiring a parameter related to a remaining life of a target disk, wherein the parameter indicates usage information of the target disk when it is used; and
applying the parameter to the model to determine the remaining life of the target disk.

14. The computer program product according to claim 13, wherein acquiring the parameter includes acquiring at least one of the following of the target disk: recoverable read error rate, start and stop count, reallocated sector count, seek error rate, power-on hours, spin-up time, reported unrecoverable error count, command timeout, airflow temperature in Celsius, load cycle count, temperature in Celsius, currently pending sector, offline uncorrectable, head flying time, total logical block address writes, and total logical block address reads.

15. The computer program product according to claim 13, wherein the model is a random forest model or a neural network model.

16. The computer program product according to claim 13, wherein the steps further include:
acquiring additional parameters for adjusting the training of the model; and
training the model by taking the set of parameters and the additional parameters as an input and taking the reference remaining life as an output.

17. The computer program product according to claim 16, wherein the additional parameters include at least one of the following:
weights of the set of parameters;
a time range between a time point when the set of parameters are acquired and a time point when the failure occurs; and
the number of trees included in the model, the model being a random forest model.

18. The computer program product according to claim 13, wherein the steps further include:
determining that the target disk needs to be replaced if it is determined that the remaining life is shorter than a threshold remaining time.
